(19) United States
(12) Patent Application Publication
(10) Pub. No.: US 2008/0089003 A1
(43) Pub. Date: Apr. 17, 2008

(54) Driving voltage output circuit

(76) Inventors: Tomokazu Kojima, Osaka (JP); Kenji Miyake, Shiga (JP); Tetsuro Omori, Osaka (JP)

Correspondence Address: MCDERMOTT WILL & EMERY LLP, 600 13TH STREET, NW, WASHINGTON, DC, 20005-3096, US

(21) Appl. No.: 11/889,926

(22) Filed: Aug. 17, 2007

(30) Foreign Application Priority Data
Oct. 17, 2006 (JP) 2006-282948

(51) Int. Cl. H02H 11/00

(52) U.S. Cl. 361/246

(57) ABSTRACT

A driving voltage output circuit is provided for selectively outputting a positive driving voltage and a negative driving voltage. The driving voltage includes: an amplifier which amplifies and outputs, as a driving voltage, a selectively input positive or negative input signal; and a power supply voltage switching circuit which switches a power supply voltage to be supplied to the amplifier according to a polarity of the input signal.

### BACKGROUND OF THE INVENTION

1. Field of the Invention

The present invention relates to a driving voltage output circuit for driving source lines or the like of a liquid crystal display device, an electroluminescence display device, or the like.

2. Background Art

In general, in liquid crystal display devices and electroluminescence display devices, source lines and the like are driven by alternative application of positive and negative driving voltages. As a technique for outputting such driving voltages, there is known a driving voltage output circuit including an output amplifier for positive driving voltage output and an output amplifier for negative driving voltage output which are exchanged selectively to output drive voltages, thereby reducing the circuit scale thereof (for example, Japanese Patent Application Laid Open Publication No. 9-26765).

### SUMMARY OF THE INVENTION

To the aforementioned driving voltage output circuit, the positive driving voltage and the negative driving voltage are applied alternatively by different output amplifiers, of which offset are different from each other, to invite variation in difference (amplification) between the positive and negative driving voltages. This may cause, in the case using it in liquid crystal display devices and the like, display irregularity and the like to degrade the image quality.

The present invention has its object of increasing the accuracy of output driving voltages. Another object of the present invention is to reduce the circuit scale of the driving voltage output circuit.

In order to achieve the above objects, an example of a circuit in accordance with the present invention is a driving voltage output circuit for selectively outputting a positive driving voltage and a negative driving voltage, which includes: an amplifier which amplifies and outputs, as a driving voltage, a selectively input positive or negative input signal; and a power supply voltage switching circuit which switches a power supply voltage to be supplied to the amplifier according to a polarity of the input signal.

In the above circuit, both the positive and negative driving voltages are output from the single amplifier, so that the difference (amplitude) between the positive and negative driving voltages is free from offset influence even if the offset of the amplifier varies. Hence, the accuracy of the driving voltages increases.

Further, the range of the actual operation voltage is reduced to approximately one half of the amplitude. This means that the elements composing the circuit can have a breakdown voltage that is one half of that of the conventional one, thereby leading to reduction in area of the elements occupying the semiconductor substrate and an increase in operation speed of the circuit.

### BRIEF DESCRIPTION OF THE DRAWINGS

FIG. 1 is a circuit diagram showing a structure of a driving voltage output circuit in accordance with Embodiment 1.

FIG. 2 is a circuit diagram showing a specific structure of a power supply circuit 110 in Embodiment 1.

FIG. 3 is a timing chart showing an operation of an input selector 103 in Embodiment 1.

FIG. 4 is a timing chart showing an operation of the power supply circuit 110 in Embodiment 1.

FIG. 5 is a circuit diagram showing a structure of an amplifier 104 in Embodiment 2.

FIG. 6 is a timing chart showing an operation of the amplifier 104 in Embodiment 2.

FIG. 7 is a circuit diagram showing a structure of an amplifier 104 in Embodiment 3.

FIG. 8 is a circuit diagram showing a structure and an operation of an output selector 301 in Embodiment 4.

FIG. 9 is a circuit diagram showing a succeeding operation of the output selector 301 in Embodiment 4.

FIG. 10 is a circuit diagram showing a further succeeding operation of the output selector 301 in Embodiment 4.

### DETAILED DESCRIPTION OF THE PREFERRED EMBODIMENTS

Embodiments of the present invention will be described below with reference to the accompanying drawings. In each of the following embodiments, the same reference numerals are assigned to elements having the same functions for omitting duplicate description thereof.

### Embodiment 1

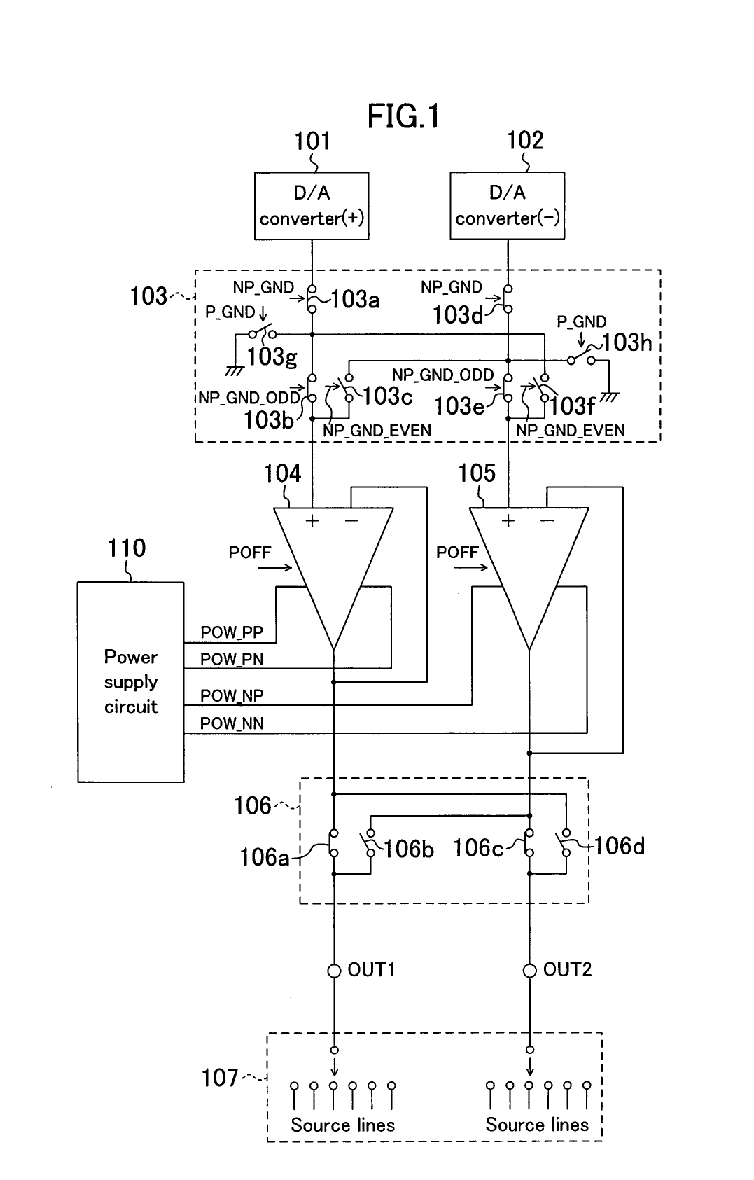

FIG. 1 is a circuit diagram showing a structure of a driving voltage output circuit for applying driving voltages to a predetermined number of source lines of, for example, a liquid crystal panel. The driving voltage output circuit includes: D/A converters 101, 102 for respectively outputting positive and negative image singal voltages on the basis of image data of the pixels; an input selector 103 for selectively exchanging the outputs of the D/A converter 101, 102; amplifiers 104, 105 of which each gain is, for example, one time; an output selector 106 for selectively exchanging the outputs of the amplifiers 104, 105; a distributing circuit 107 for connecting the output of the output selector 106 sequentially to the source lines; and a power supply circuit 110 for supplying two power supply voltages to each amplifier 104, 105.

The input selector 103 includes switches 103a to 103f for exchanging the sites where the image signal voltages from the respective D/A converters 101, 102 are to be input between the amplifiers 104 and 105 and the amplifiers 105 and 104. The input selector 103 also includes switches 103g and 103h for allowing the input terminals of the amplifiers 104, 105 to be once grounded in reversing the polarities of the image signal voltages to be input to the amplifiers 104, 105, respectively.

Though it is preferable to use high voltage transistors having a high breakdown voltage of, for example, AVDD minus NVDD or the like as the switches 103a to 103f, appropriate setting of ON/OFF timing and appropriate level shifting of control signals enable the use of low voltage transistors having, for example, one half of the above breakdown voltage as the switches 103a to 103f.

Each amplifier 104, 105 is composed of, for example, an operational amplifier and outputs a driving voltage having the same polarity as an input image signal voltage when power supply voltages (POW_PP, POW_PN, POW_NP, POW_NN) corresponding to the polarities of the input image signal voltages are supplied.

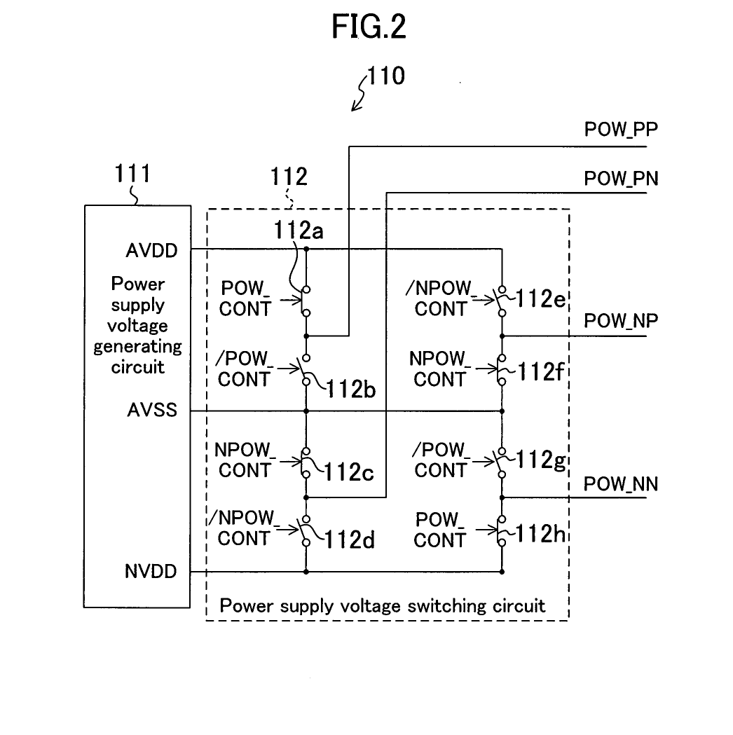

The power supply circuit 110 includes, as shown in FIG. 2, a power supply voltage generating circuit 111 for generating voltages AVDD, AVSS, and NVDD and a power supply voltage switching circuit 112. The power supply voltage switching circuit 112 includes switches 112a to 112h controlled by control signals (POW_CONT, /POW_CONT, NPOW_CONT, and /NPOW_CONT: “/” means inverse) so as to reverse the voltages, specifically, so that the power supply voltages POW_PP and POW_PN to the amplifier 104 are changed to AVDD and AVSS, respectively, and that the power supply voltages POW_NP and POW_NN to the amplifier 105 are changed to AVSS and NVDD, respectively.

The output selector 106 shown in FIG. 1 includes switches 106a to 106d for selectively connecting the outputs of the amplifiers 104, 105 to output pads OUT1 and OUT2 of a semiconductor chip.

The distributing circuit 107, which is provided at, for example, a liquid crystal panel, applies driving voltages input through the output pads OUT1 and OUT2 to the source lines sequentially.

An operation of the thus structured driving voltage output circuit will be described next.

Image data of the pixels is input to the D/A converters 101, 102 from, for example, a shift register via a latch circuit and a level shifter, though not shown. A positive image signal voltage corresponding to the image data is output from the D/A converter 101 while a negative image signal voltage corresponding thereto is output from the D/A converter 102.

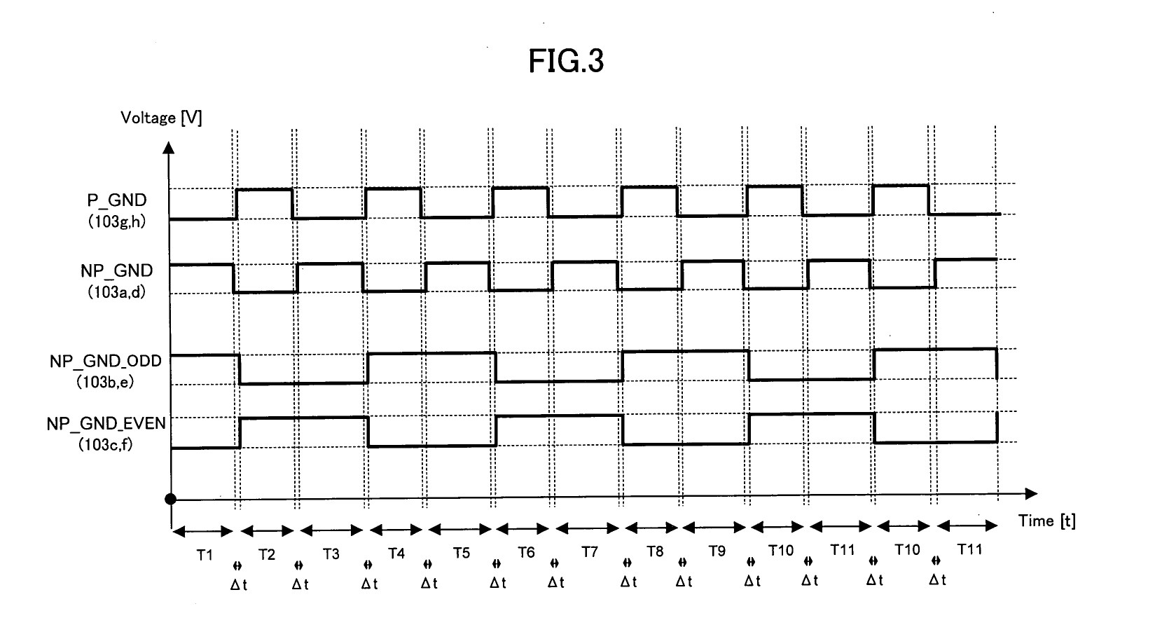

In the input selector 103, the switches 103a to 103h are controlled by the control signals shown in FIG. 3. Specifically, in a period T1, the switches 103a, 103d are ON and the switches 103b, 103e are ON, so that the positive and negative image singal voltages from the D/A converters 101, 102 are input into the amplifiers 104, 105, respectively.

In a period T2 after a lapse of a float At after the switches 103a, 103d become OFF, the switches 103c, 103f rather than the switches 103b, 103e are ON and the switches 103g, 103h are once ON, so that the input terminals of the amplifiers 104, 105 are grounded. This definitely prevents amplification of a one-cycle previous image signal voltage to the amplifiers 104, 105 at exchange of the polarities of the power supply voltages supplied, as will be described later.

Next, in a period T3, the switches 103a, 103d are ON again. Accordingly, the image signal voltages from the D/A converters 102, 101 of which polarities are reverse to those in the period T1 are input to the amplifiers 104, 105, respectively. Thereafter, the same operation is repeated.

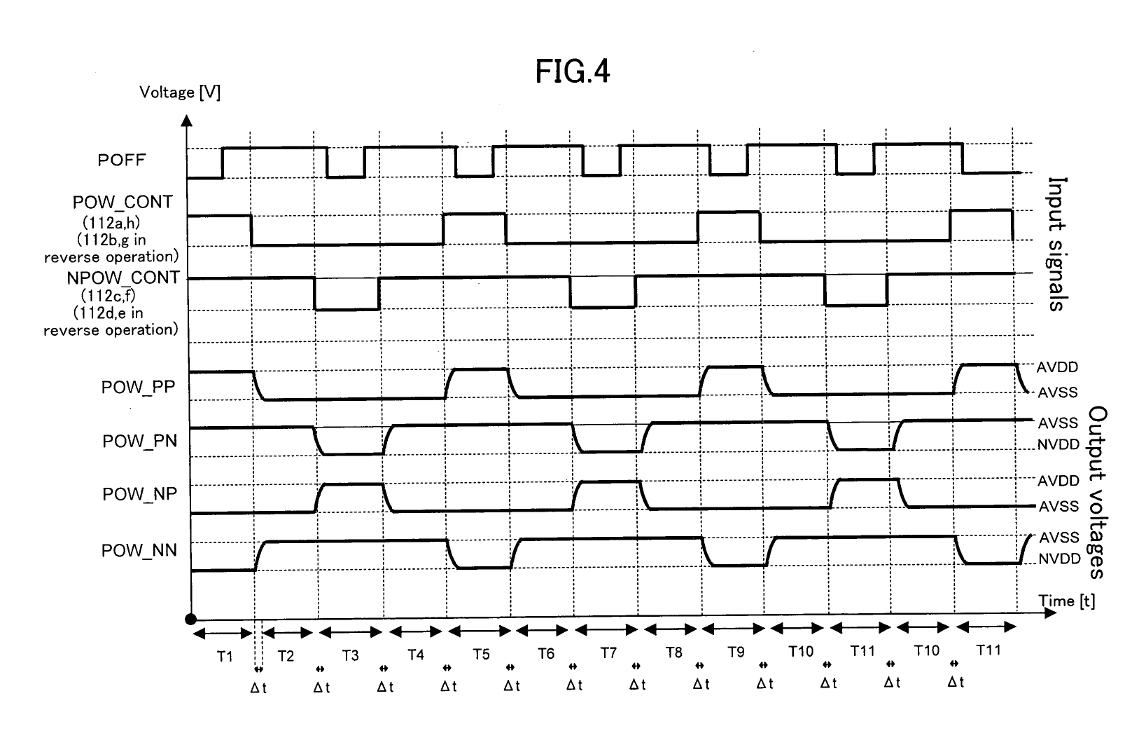

The amplifiers 104, 105 and the power supply circuit 110 perform control and amplification of the power supply voltages, as shown in FIG. 4.

Specifically, in the period T1:

the control signals POW_CONT and /POW_CONT are at H (High) level and L (Low) level, respectively;

the switches 112a, 112c, 112f, 112h are ON while the switches 112b, 112d, 112e, 112g are OFF;

the high potential side power supply potential POW₁₃ PP to the amplifier 104 is set at the power supply potential AVDD;

the low potential side power supply potential POW_PN to the amplifier 104 is set at the power supply potential AVSS;

the high potential side power supply potential POW_NP to the amplifier 105 is set at the power supply potential AVSS; and

the low potential side power supply potential POW_NN to the amplifier 104 is set at the power supply potential NVDD.

In this state, the amplifiers 104, 105 output driving voltages having polarities and levels corresponding to the positive and negative image signal voltages input from the D/A converters 101, 102, respectively.

In the end of the period T1, after a power off signal POFF becomes at H level to turn the amplifiers 104, 105 OFF (non-operating state):

POW_CONT and /POW_CONT become at L level and H level, respectively, so that the switches 112a, 112h of the power supply voltage switching circuit 112 are OFF while the switches 112b, 112g thereof are ON; and

the high potential side power supply potential POW_PP to the amplifier 104 and the low potential side power supply potential POW_NN to the amplifier 105 are set at the power supply voltage AVSS.

Next, in the period T3 after a lapse of the predetermined period T2:

NPOW_CONT and /NPOW_CONT are at L level and H level, respectively;

the switches 112c, 112f are OFF while the switches 112d, 112e are ON;

the low potential side supply potential POW_PN to the amplifier 104 is set at the supply potential NVDD; and

the high potential side power supply potential POW_NP to the amplifier 105 is set at the power supply potential AVDD.

Thereafter, the power off signal POFF becomes at L level to allow the amplifiers 104, 105 to be in the operating state. Specifically, as described above, the polarities of the image singal voltages input to the amplifiers 104, 105 are reversed and the polarities of the supplied power supply voltages are reversed as well, so that the polarities of the driving voltages to be output are also reversed.

In the end of the period T3, the power off signal POFF becomes at H level similarly to that in the period T1 to turn the amplifiers 104, 105 OFF, and then:

NPOW_CONT and INPOW_CONT are at H level and L level, respectively;

the switches 112c, 112f are ON while the switches 112d, 112e are OFF; and

the low potential side power supply potential POW_PN to the amplifier 104 and the high potential side power supply potential POW_NP to the amplifier 105 are set at the power supply potential AVSS.

In a period T5 after a lapse of the predetermined period T4:

POW_CONT and /POW_CONT are at H level and L level, respectively;

the switches 112a, 112h are ON while the switches 112b, 112g are OFF;

the high potential side power supply potential POW_PP to the amplifier 104 is set at the power supply potential AVDD; and

the low potential side power supply potential POW_NN to the amplifier 105 is set at the power supply potential NVDD.

Subsequently, the power off signal POFF becomes at L level to allow the amplifiers 104, 105 to be in the operating state. Then, the same operation as above is repeated.

The driving voltages output from the amplifiers 104, 105 to which the power supply voltages are thus supplied are input to the distributing circuit 107 of the liquid crystal panel via the output selector 106 and the output pads OUT1, OUT2 and are then applied to the source liens sequentially. Herein, each source line receives a driving voltage output always from the same amplifier 104 or 105. Accordingly, the difference (amplitude) between the positive and negative driving voltages applied to each source line is free from offset influence of the amplifiers 104, 105 even if offsets are different between the amplifiers 104, 105. Hence, an increase in accuracy of the driving voltages can be achieved by this simplified configuration.

Application of the driving voltages of the amplifiers 104, 105 to the source lines is controlled. In detail, switching in the distributing circuit 107 is controlled so that the driving voltages are applied to adjacent source lines at different timings. Because: application of driving voltages having polarities reverse to each other to adjacent source lines will cause noise (interference). Therefore, it is preferable to apply a driving voltage to at least every other source line. More preferably, for example, the driving voltages of the amplifiers 104, 105 are applied to source lines spaced one half of the width of a source line group always apart from each other (supposing that one of the driving voltages is applied to source lines sequentially from a source line at one end, the other driving voltage is applied to source lines sequentially in the same direction from a source line at the center).

As described above, supply of the power supply voltages having polarities corresponding to the image singal voltages input to the amplifiers 104, 105 achieves an increase in accuracy of the output driving voltages. Further, the range of the actual operation voltage reduces to approximately one half of the range between AVDD and NVDD, which enables straightforward employment of low voltage transistors as the amplifiers 104, 105, leading to reduction in area of the elements, such as transistors occupying the semiconductor substrate. In addition, the narrow range of the actual operation voltage leads to high-speed operation, with a result that selective driving of sequential driving voltage application to multiple source lines is facilitated further.

### Embodiment 2

Various kinds of amplifiers operated by two power supply voltages, such as operational amplifiers can be employed as the amplifiers 104, 105. While, the amplifiers 104, 105 are only require to output positive and negative driving voltages selectively, as described above, and accordingly can be simplified and reduced in its circuit scale when the states of the amplifiers can be selectively exchanged between a current source state and a current sink state.

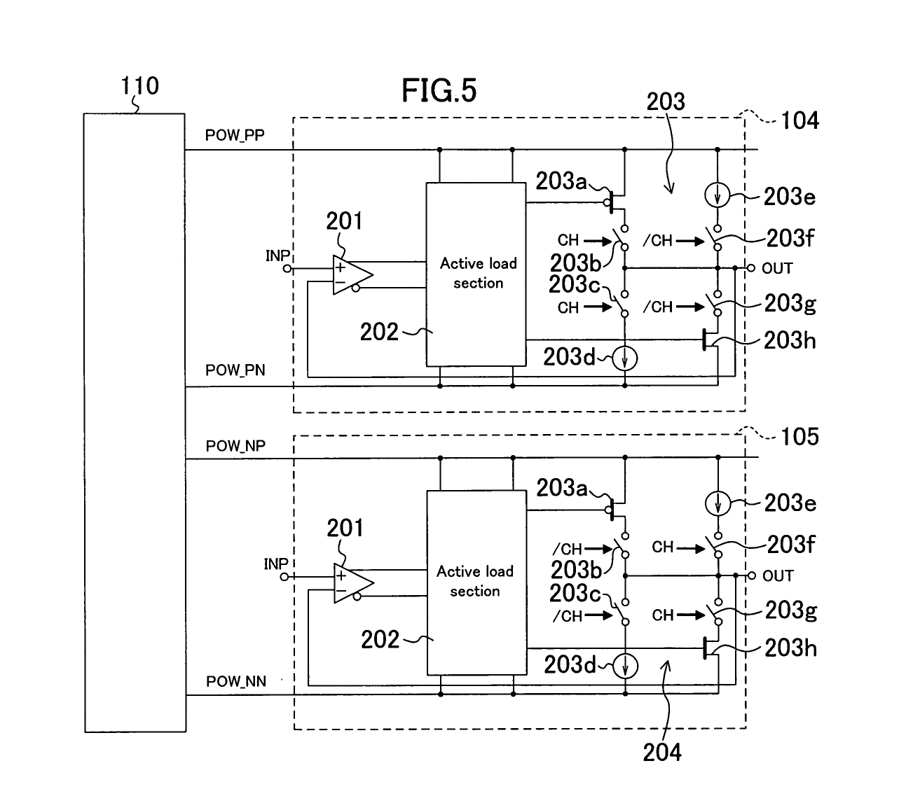

Specifically, the amplifier 104 is composed of, as shown in FIG. 5, a differential section 201, an active load section 202, and an output section 203, similarly to general operational amplifiers. The output section 203 includes a P-channel transistor 203a, switches 203b, 203c, constant current sources 203d, 203e, switches 203f, 203g, and an N-channel transistor 203h. An output section 204 of the amplifier 105 has the same configuration as the output section 203 of the amplifier 104. In the output section 203 of the amplifier 104, the switches 203b, 203c are controlled by a control signal CH and the switches 203f, 203g are controlled by a control signal /CH. In contrast, in the output section 204 of the amplifier 105, the switches 203b, 203c, 203f, 203g are controlled by control signals respectively reverse to those in the output section 203. Each of the switches 203b, 203c, 203f, 203g may be a single transistor and preferably is a transfer gate in general.

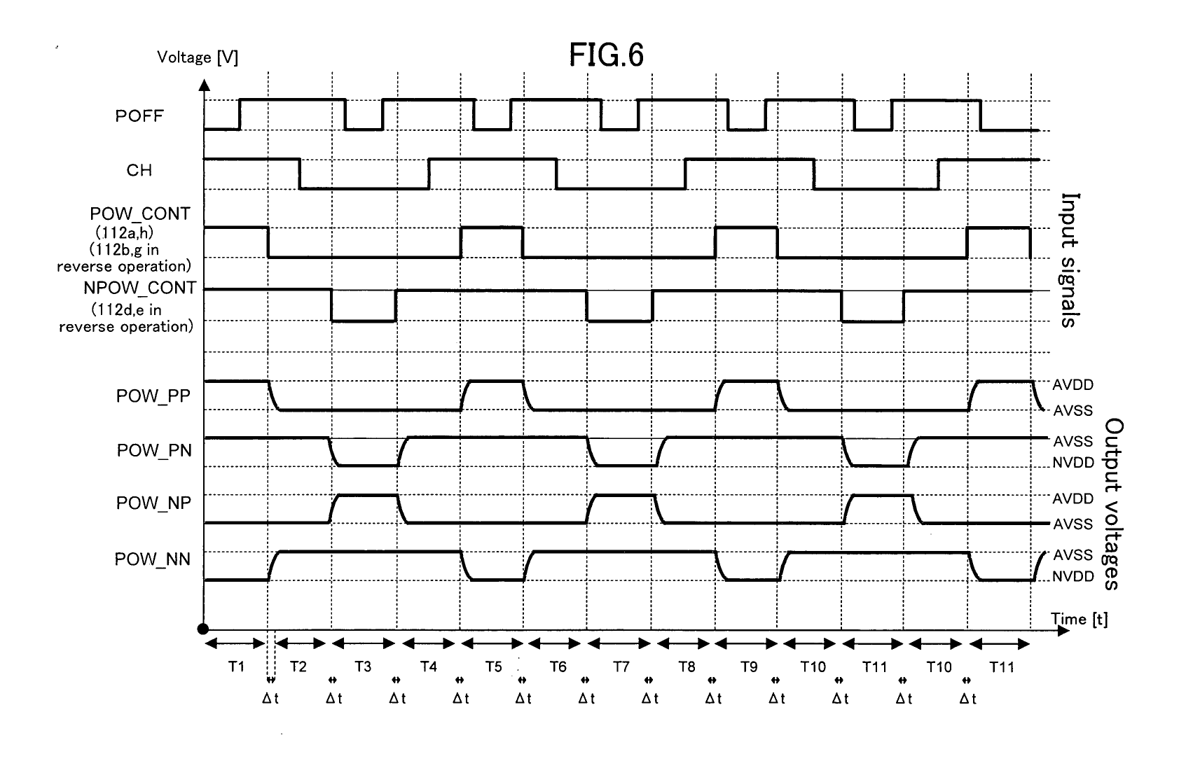

In the case where the above configuration are employed in the amplifiers 104, 105, the control signals CH and /CH are at H level and L level, respectively, in the period T1, as shown in FIG. 6, so that the switches 203b, 203c are ON while the switches 203f, 203g are OFF in the amplifier 104 to allow the amplifier 104 to be in the current source state. On the other hand, the switches 203b, 203c are OFF while the switches 203f, 203g are ON in the amplifier 105 to allow the amplifier 105 to be in the current sink state.

In the period T3, the control signals CH and /CH are at L level and H level, respectively, to allow the amplifiers 104, 105 to be in the current sink state and the current source state, respectively. The operations of the amplifiers 104, 105 under this condition are the same as those in Embodiment 1, and accordingly, the operation of the driving voltage output circuit is the same as that in Embodiment 1 as a whole. Hence, the accuracy of the driving voltages increases and further reduction in circuit scale is achieved with the above simplified configuration. Further, reduction in idling current and in power consumption can be achieved.

### Embodiment 3

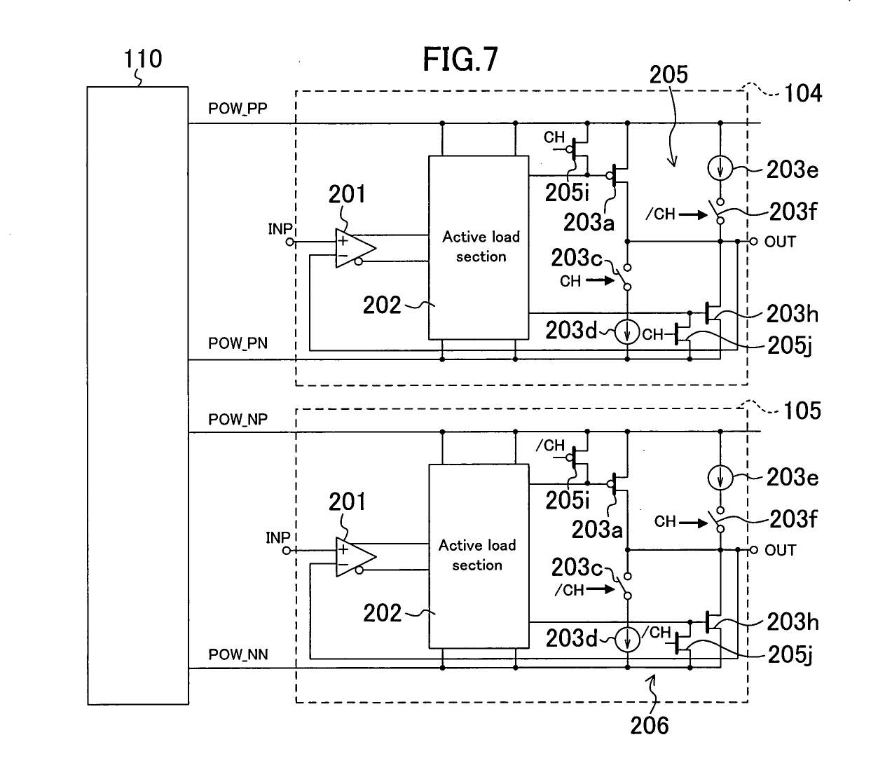

The amplifiers 104, 105 may have configurations shown in FIG. 7. In the example shown in FIG. 7, each output section 205, 206 includes transistors 205i, 205j in place of the switches 203b, 203g of the above-described output sections 203, 204. The transistors 205i, 205j control the gate potential of the transistors 203a, 203h, respectively, to turn the respective transistors 203a, 203h ON/OFF forcedly. With this configuration, though the switching speed is liable to decrease when compared with that in Embodiment 2, influence of ON resistance of the switches 203b, 203g can be avoided.

### Embodiment 4

In Embodiment 1, the switches 106a to 106d of the output selector 106 must be composed of high voltage transistors and the like. In detail, when the site where the positive driving voltage output from, for example, the amplifier 104 is switched from the source lines connected to the output pad OUT1 to the source lines connected to the output pad OUT2, the differential voltage (AVDD minus NVDD at the maximum) between the potential of the charge accumulated in the source lines before switching and the potential output from the amplifier 104 after switching is applied to the switches 106a to 106d, and therefore, the switches 106a to 106d must have a breakdown voltage over the differential voltage.

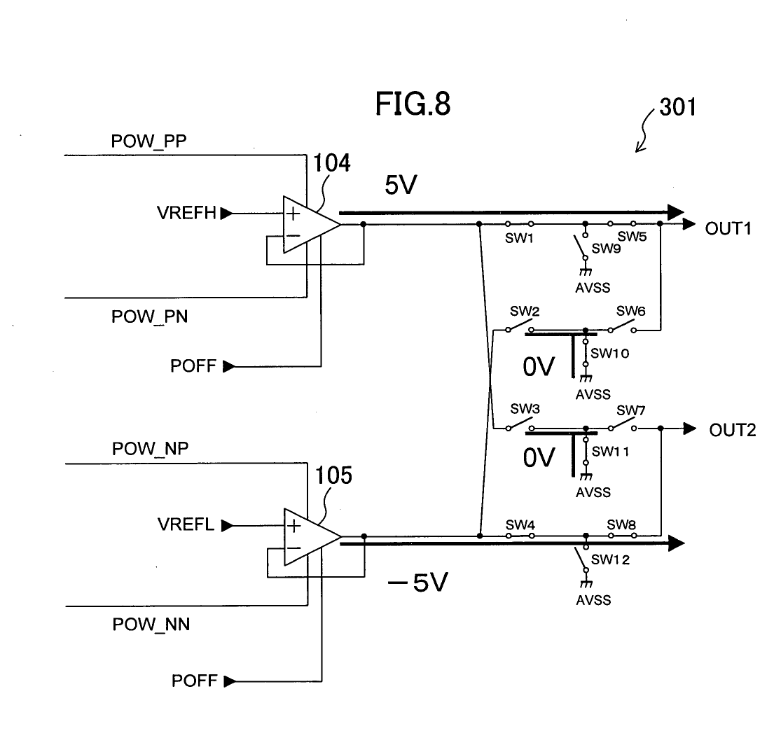

In view of the foregoing, an output selector 301 including switches SW1 to SW12 shown in FIG. 8 to FIG. 10 is employed and is controlled as follows to secure the operation of the low voltage transistors of the amplifiers 104, 105. The following control enables employment of low voltage transistors as the switches SW1 to SW12, as well.

First, as shown in FIG. 8, for outputting respective driving voltages of +5V and −5V output from the respective amplifiers 104, 105 into the respective output pads OUT1, OUT2, the switches SW1, SW4, SW5, SW8 are controlled to be ON while at the same time, the switches SW10, SW11 are controlled to be ON. This suppresses the absolute values of the voltages applied to the respective terminals of each switch SW2, SW3, SW6, SW7 to 5V or lower definitely.

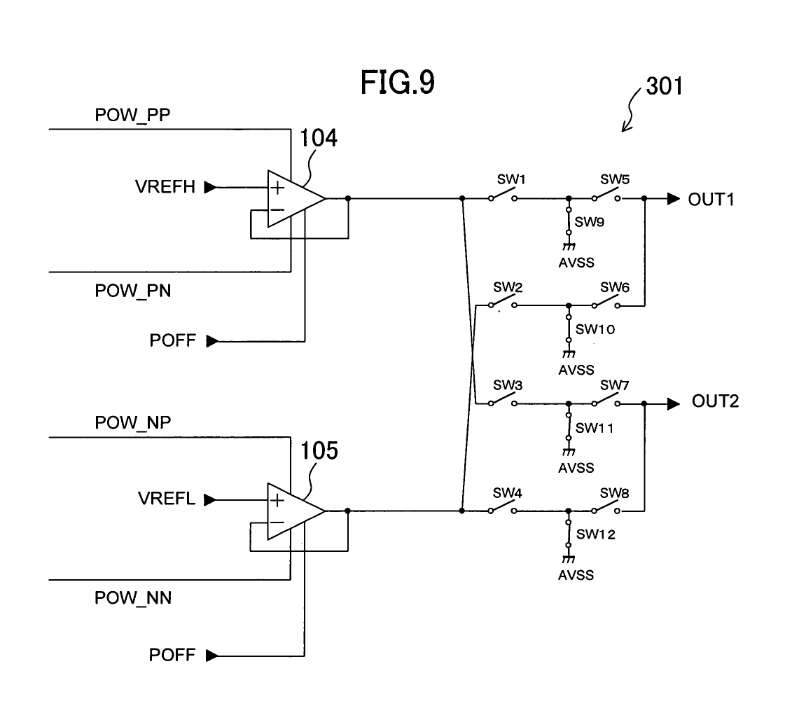

Next, in switching the driving voltages output from the amplifiers 104, 105 so as to be output into the output pads OUT2, OUT1, respectively, the switches SW1, SW4, SW5, SW8 are controlled to be OFF while the switches SW9, SW12 in addition to the switches SW10, SW11 are controlled to be ON first, as shown in FIG. 9. This also suppresses the absolute values of the voltages applied to the respective terminals of each switch SW1 and the like to 5V or lower definitely.

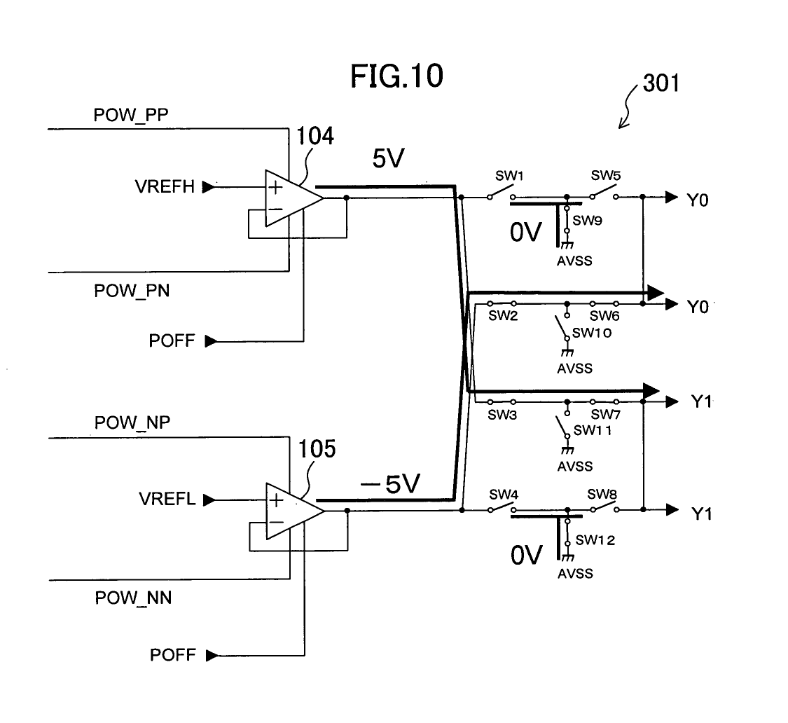

Subsequently, with slight time lags interposed, the switches SW6, SW7 become ON, the switches SW10, SW11 become OFF, and the switches SW2, SW3 become ON, so that the state is switched to the output state shown in FIG. 10 with the voltages at the respective terminals of each switch suppressed low.

Each ON/OFF time difference among the switches SW6, SW7, SW10, SW11, SW2, SW3 is set within the range where the voltages at each terminal of the switches can be kept lower than the breakdown voltage transitively. Preferably, the shorter a time period during when the source lines are grounded forcedly, the better it is.

The switches SW9, SW10, SW11, SW12 exhibit an effect of preventing overvoltage of the amplifiers 104, 105. The mechanism thereof will be described below.

Suppose that the state is switched from the state shown in FIG. 8 to the state shown in FIG. 10 without using the switches SW1 to SW12. In the instant of being the state shown in FIG. 10, the previous voltage of 5V is kept at the terminal Y0 while at the same time the amplifier 105 is outputting a voltage of −5V. Though no problem arises if the impedance of the amplifier 105 is sufficiently low, a voltage of 5V may be applied at the maximum to the output of the amplifier 105, inviting application of a voltage over the breakdown voltage. In view of this, in switching the state from the state shown in FIG. 8 to the state shown in FIG. 10 or vise versa, the state shown in FIG. 9 is interposed to set the terminals Y0 and Y1 once to be 0V, so that a voltage of 0V is applied to the outputs of the amplifiers 104, 105 at the worst. Thus, the differences of the voltages output from the output voltages of the amplifiers 104, 105 are suppressed to 5V or lower definitely. The amplifiers 104, 105, which should have amplified a voltage by 10V between −5V and 5V conventionally, is enough to amplify a voltage by only 5V between 0V and 5V or 0V and −5V in the present invention, and hence, high-speed operation can be achieved.

As described above, the present invention increases the accuracy of the output driving voltages. As well, the circuit scale of the driving voltage output circuit can be reduced.

What is claimed is:

1. A driving voltage output circuit for selectively outputting a positive driving voltage and a negative driving voltage, comprising:
an amplifier which amplifies and outputs, as a driving voltage, a selectively input positive or negative input signal; and
a power supply voltage switching circuit which switches a power supply voltage to be supplied to the amplifier according to a polarity of the input signal.

2. The driving voltage output circuit of claim 1,
wherein a state of the amplifier is switched selectively between a current source state and a current sink state according to the polarity of the input signal.

3. The driving voltage output circuit of claim 1,
wherein a potential of an input terminal of the amplifier is grounded prior to reversion of a polarity of the driving voltage.

4. The driving voltage output circuit of claim 3, further comprising:
an input selector which inputs to the amplifier a positive polarity input signal source or a negative polarity input signal source selectively, the input selector including:
first and second positive polarity switches provided in series between the positive polarity input signal source and the amplifier;
first and second negative polarity switches provided in series between the negative polarity input signal source and the amplifier; and
ground switches connected between a ground and a connecting line between the first and second positive polarity switches and between the ground and a connecting line between the first and second positive polarity switches.

5. The driving voltage output circuit of claim 1,
wherein the amplifier includes first and second amplifiers which output driving voltages of which polarities are reverse to each other, and
a distributing circuit is provided which outputs the driving voltages output from the first and second amplifiers sequentially and selectively to a plurality of driven electrodes, the distributing circuit outputting the driving voltages output from the first and second amplifiers to at least every other driven electrode.

6. The driving voltage output circuit of claim 1,
wherein the amplifier includes first and second amplifiers which output driving voltages of which polarities are reverse to each other,
an output selector is provided which selectively switches a state between a first state and a second state, the first state being a sate where the driving voltage output from the first amplifier is output to a first driven electrode while the driving voltage output from the second amplifier is output to a second driven electrode, and the second state being a state where the driving voltage output from the first amplifier is output to the second driven electrode while the driving voltage output from the second amplifier is output to the first driven electrode, and
potentials of the first and second driven electrodes are grounded prior to state switch between the first state and the second state.

7. The driving voltage output circuit of claim 6,
wherein the output selector includes:
pairs of first switches and second switches respectively provided in series between the first amplifier and the first driven electrode, between the first amplifier and the second driven electrode, between the second amplifier and the first driven electrode, and between the second amplifier and the second driven electrode; and
grounding switches connected between the ground and the connecting lines between the respective pairs of the first and second switches.
